(19) United States
(12) Patent Application Publication
(10) Pub. No.: US 2007/0298740 A1
(43) Pub. Date: Dec. 27, 2007

(54) FM RADIO RECEIVER

(75) Inventors: Hiroshi TERAOKA, Osaka (JP); Naoki MATSUSHITA, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 11/761,689

(22) Filed: Jun. 12, 2007

(30) Foreign Application Priority Data
Jun. 14, 2006 (JP) 2006-164348

(51) Int. Cl. H04B 1/18

(52) U.S. Cl. 455/179.1; 455/188.1

(57) ABSTRACT

An FM radio receiver includes an antenna. A high frequency signal received by the antenna ranges from an FM radio broadcast band to a television broadcast band assigned to higher frequencies. An LPF has an attenuated area corresponding to a television channel at a frequency higher out of two television channels causing intermodulation interference with the FM radio broadcast band. A part of the frequency component constituting the high frequency signal received by the antenna is extracted by the LPF. A mixer mixes a high frequency signal having the frequency component extracted by the LPF with a local oscillation frequency signal to thereby output an intermediate frequency signal. A demodulator circuit creates an audio signal for an FM radio broadcast on the basis of the intermediate frequency signal output from the mixer.

### CROSS REFERENCE OF RELATED APPLICATION

The disclosure of Japanese Patent Application No. 2006-164348 is incorporated herein by reference.

### BACKGROUND OF THE INVENTION

1. Field of the Invention

The present invention relates to an FM radio receiver. More specifically, the present invention relates to an FM radio receiver receiving an FM radio signal broadcasted at a second frequency band lower in frequency than that of a first frequency band at which a television signal is broadcasted.

2. Description of the Related Art

One example of such a kind of the receiver is disclosed in a patent document 1 (Japanese Patent application Laid-open No. 2004-282464). The related art intendeds to utilize an AGC voltage based on a video baseband signal in receiving a television broadcast while utilizing an AGC voltage based on an output from a mixer so as to apply AGC to an RF amplifier in receiving an FM broadcast without a video signal. Thus, it is possible to reduce intermodulation interference causing in the mixer. However, in a gain control to the RF amplifier like the related art, there is a limit to reduction in intermodulation interference, and therefore, a broadcast program might not be heard comfortably.

### SUMMARY OF THE INVENTION

Therefore, it is a primary object of the present invention to provide a novel FM radio receiver.

Another object of the present invention is to provide an FM radio receiver capable of comfortably listening to a radio broadcast.

An FM radio receiver according to this invention comprises: an antenna receiving a high frequency signal ranging from a first frequency band for FM radio broadcast to a second frequency band for television broadcast; a mixer for mixing the high frequency signal obtained by the antenna with a local oscillation frequency signal to create an intermediate frequency signal; and a filter provided between the antenna and the mixer, and having an attenuated area corresponding to at least one television channel out of two television channels causing intermodulation interference with the first frequency band.

A high frequency signal received by an antenna ranges from a first frequency band for FM radio broadcast to a second frequency band for television broadcast. A mixer mixes the high frequency signal with a local oscillation frequency signal to create an intermediate frequency signal. Also, a filter is provided between the antenna and the mixer. The filter has an attenuated area corresponding to at least one television channel out of two television channels causing intermodulation interference with the first frequency band.

By providing the filter having the attenuated area corresponding to a television channel causing intermodulation at the front of the mixer, it is possible to reduce intermodulation interference with the FM radio broadcast. Thus, it is possible to comfortably listen to the FM radio broadcast.

In one aspect, the attenuated area included in the filter corresponds to the television channel farther from the first frequency band out of the two television channels. Thus, it is possible to retain high receiver sensitivity with respect to the FM radio broadcast.

In another aspect, the second frequency band is assigned to a frequency higher than the first frequency band.

In still another aspect, the filter includes an inductor and a first capacitor connected in parallel with each other for LC resonance. This makes it possible to obtain a good filter characteristic.

It is preferable that the filter further includes a second capacitor provided between one end of the inductor and a plane of reference potential, and a third capacitor provided between the other end of the inductor and the plane of reference potential.

In another aspect, a first amplifier for amplifying an output of the filter is provided between the filter and the mixer. Thus, the level of the FM radio signal is increased in comparison with the level of the television signal.

In still another aspect, the FM radio receiver further comprises an extractor for extracting a predetermined frequency component included in the intermediate frequency signal; a second amplifier for amplifying the predetermined frequency component extracted by the extractor; and a demodulator for demodulating the predetermined frequency component amplified by the second amplifier.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of one embodiment of the present invention;

FIG. 2 is a circuit diagram showing one example of a configuration of an LPF applied to FIG. 1 embodiment;

FIG. 3 is a graph showing one example of a frequency response in FIG. 2 embodiment;

FIG. 4 is an illustrative view showing one example of a state of assignment of frequencies of an FM radio broadcast and a television broadcast;

FIG. 5 is a circuit diagram showing one example of a configuration of a trap filter applied to another embodiment; and

FIG. 6 is a graph showing one example of a frequency response in FIG. 5 embodiment.

### DETAILED DESCRIPTION OF THE PREFERRED EMBODIMENTS

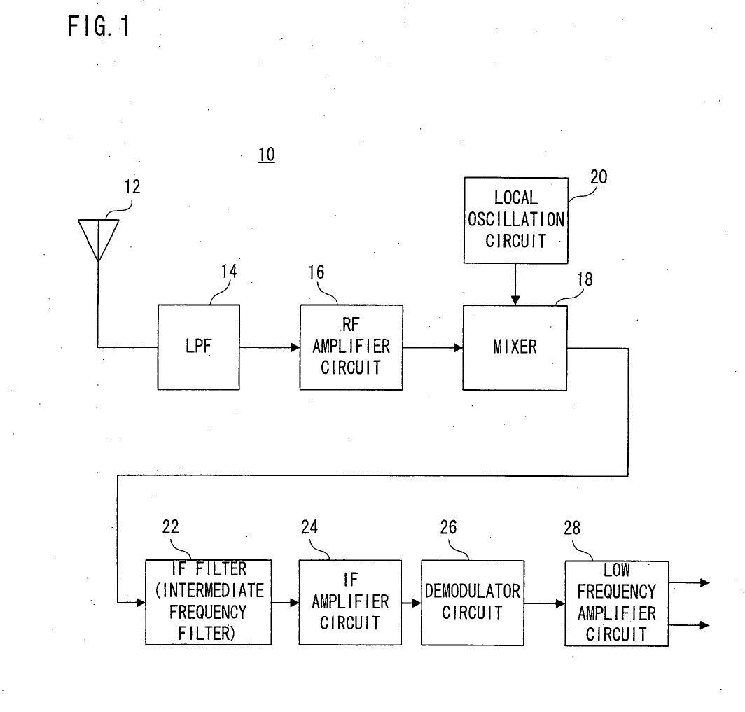

Referring to FIG. 1, an FM radio receiver 10 of this embodiment includes an antenna 12. A high frequency signal received by the antenna 12 has a frequency band for an FM radio broadcast from 76 MHz to 90 MHz and a frequency band for a television broadcast above 90 MHz. An LPF 14 extracts a part of the frequency component forming the high frequency signal received by the antenna 12. A high frequency signal having the extracted frequency component is subjected to amplifier processing by an RF amplifier circuit 16.

A mixer 18 mixes the high frequency signal amplified by the RF amplifier circuit 16 with a local oscillation frequency signal output from a local oscillation circuit 20. The mixer 18 outputs an intermediate frequency signal. An intermediate frequency filter 22 extracts a predetermined intermediate frequency component. An intermediate frequency signal having the extracted frequency component is amplified by an IF amplifier circuit 24, and then demodulated by a demodulator circuit 26. Thus, a broadcast audio signal broadcasted from a desired FM radio station is created. The created broadcast audio signal is output from a speaker not shown through a low frequency amplifier circuit 28.

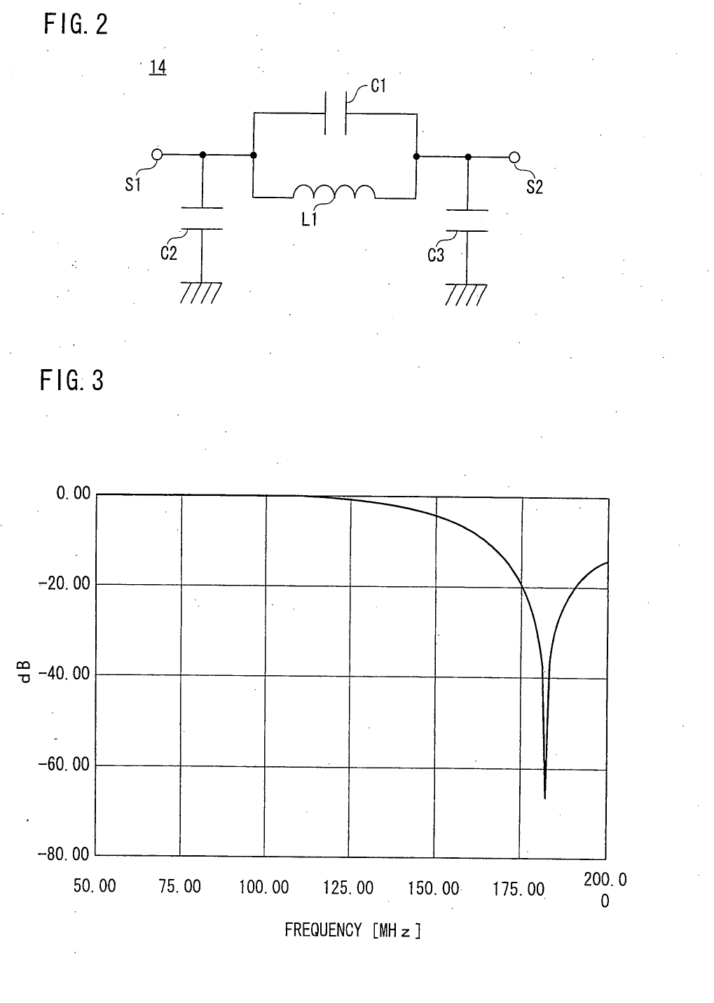

The LPF 14 is an LC resonant type low-pass filter, and constructed as shown in FIG. 2. An input terminal S1 is connected to the antenna 12, and an output terminal S2 is connected to the RF amplifier circuit 16. One end of an inductor L1 is connected with the input terminal S1, the other end thereof is connected with the output terminal S2, and a capacitor C1 is connected in parallel to the inductor L1. A capacitor C2 is inserted between the input terminal S1 and a plane of reference potential, and a capacitor C3 is inserted between the output terminal S2 and a plane of reference potential. Here, the capacitor C1 has a capacity of 15 pF, and each of the capacitors C2 and C3 has a capacity of 10 pF. Furthermore, the inductor L1 has a coefficient of induction of 51 nH. The LPF 14 thus constructed has a frequency response as shown in FIG. 3. According to FIG. 3, a frequency band from near 175 MHz to near 190 MHz is an attenuated area where a gain is below −20 dB.

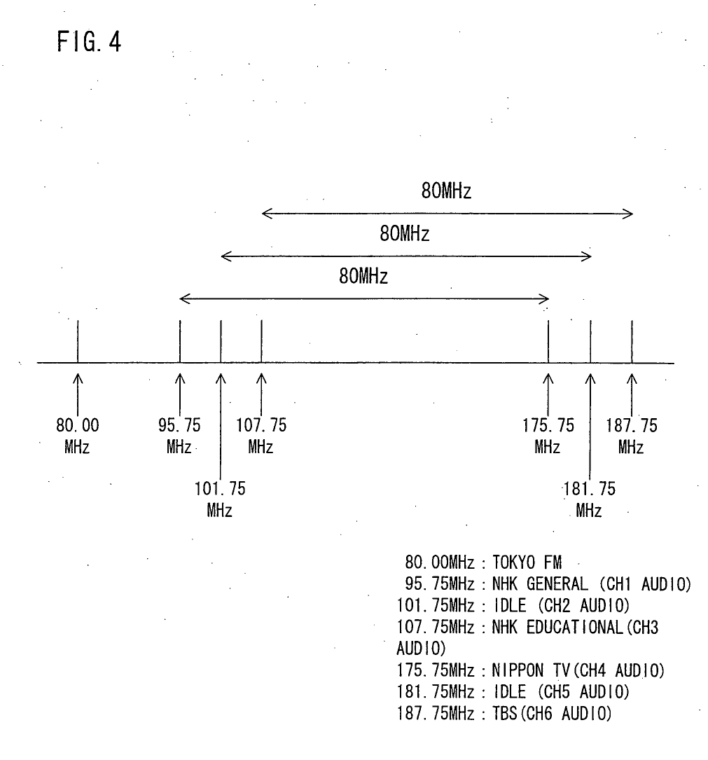

FIG. 4 shows an assignment of frequencies for an FM radio broadcast and a television broadcast in the Kanto area. A broadcast audio signal of Tokyo FM Radio is broadcasted at a frequency of 80.00 MHz. A broadcast audio signal of an NHK General TV (CH1) is broadcasted at a frequency of 95.75 MHz, and a broadcast audio signal of an NHK Educational TV (CH3) is broadcasted at a frequency of 107.75 MHz. In addition, a broadcast audio signal of Nippon Television (CH4) is broadcasted at a frequency of 175.75 MHz, and a broadcast audio signal of TBS (CH6) is broadcasted at a frequency of 187.75 MHz. Furthermore, idle channels are applied to 101.75 MHz (CH2) and 181.75 MHz (CH5).

The difference between the audio frequency of the channel CH1 (=95.75 MHz) and the audio frequency of the channel CH4 (=175.75 MHz) is 80 MHz, and the difference between the audio frequency of the channel CH3 (=107.75 MHz) and the audio frequency of the channel CH6 (=187.75 MHz) is 80 MHz. Thus, a broadcast audio of Tokyo FM Radio is interfered by intermodulation between a broadcast audio of NHK General TV and a broadcast audio of Nippon TV, or intermodulation between a broadcast audio of NHK Educational TV and a broadcast audio of TBS. The main reason of the intermodulation interference is due to nonlinearity of the mixer 18.

Thus, in this embodiment, the LPF 14 having a frequency response shown in FIG. 3 is provided at the front of the mixer 18. The attenuated area of the LPF 14 also includes the audio frequency (=175.75 MHz) of the channel CH4 out of the two channels CH1 and CH4 causing intermediation interference. The attenuated area of the LPF 14 includes the audio frequency (=187.75 MHz) of the channel CH6 out of the two channels CH3 and CH6 causing intermodulation. This makes it possible to prevent intermodulation interference with the broadcast audio of Tokyo FM Radio. The audio frequency included in the attenuated area of the LPF 14 is an audio frequency of a channel at a frequency higher out of the two channels causing the intermodulation interference. Thus, a frequency signal equal to or less than 110 MHz is scarcely suppressed, capable of restraining high receiver sensitivity with respect to the broadcast audio of the channel CH3 as well as the FM radio broadcast.

Just for reference, a Table 1 is an experimental result showing how different a resistance to intermodulation interference is depending on the presence or absence of the LPF 14. The experiment shows measure of intermodulation interference characteristics when an FM radio broadcasting signal having an electric field strength of “weak”, “medium”, or “strong” is received assuming that broadcast is performed at audio frequencies of all the channels CH1-CH.

It should be noted that “resistance” means a limit value capable of listening to an FM radio broadcast without pleasantness, and is represented by a numerical value obtained by subtracting a wave level of the FM radio broadcasting signal (expected wave level) from a wave level of the intermodulated interfered signal (interfering wave level). Furthermore, the expected wave level in a weak electric field is assumed to be 22 dB μ, the expected wave level in a medium electric field is assumed to be 65 dBμ, and the expected wave level in a strong electric field is assumed to be 100 dBμ.

TABLE 1

| | | RESISTANCE: | | |
|---|---|---|---|---|
| | | INTERFERING WAVE | | |
| | | LEVEL-EXPECTED | | |
| | | WAVE LEVEL | | |
| | | (dB) | | IMPROVE- |
| | STRENGTH OF | | PRES- | MENT |
| TV | ELECTRIC | ABSENCE | ENCE OF | FACTOR |
| CHANNEL | FIELD | OF LPF | LPF | (dB) |
| CH1-CH4 | WEAK | 46 | 55 | 9 |
| | MEDIUM | 22 | 31 | 9 |
| | STRONG | 5 | 16 | 11 |
| CH2-CH5 | WEAK | 46 | 57 | 11 |
| | MEDIUM | 23 | 33 | 10 |
| | STRONG | 6 | 15 | 9 |
| CH3-CH6 | WEAK | 47 | 57 | 10 |
| | MEDIUM | 25 | 35 | 10 |
| | STRONG | 7 | 14 | 7 |

EXPECTED WAVE LEVEL OF FM RADIO SIGNAL
WEAK: 22 dBμ
MEDIUM: 65 dBμ
STRONG: 100 dBμ

According to the Table 1, in the absence of the LPF 14, a resistance to an interfering wave due to the channels CH1 and CH4 is 46 dB in the weak electric field, 22 dB in the medium electric field, and 5 dB) in the strong electric field. Furthermore, a resistance to an interfering wave due to the channels CH2 and CH5 is 46 dB in the weak electric field, 23 dB in the medium electric field, and 6 dB) in the strong electric field. In addition, a resistance to an interfering wave due to the channels CH3 and CH6 is 47 dB in the weak electric field, 25 dB) in the medium electric field, and 7 dB) in the strong electric field.

On the contrary thereto, in the presence of the LPF 14, a resistance to an interfering wave due to the channels CH1 and CH4 is 55 dB in the weak electric field, 31 dB in the medium electric field, and 16 dB) in the strong electric field. Furthermore, a resistance to an interfering wave due to the channels CH2 and CH5 is 57 dB) in the weak electric field, 33 dB) in the medium electric field, and 15 dB) in the strong electric field. In addition, a resistance to an interfering wave due to the channels CH3 and CH6 is 57 dB in the weak electric field, 35 dB in the medium electric field, and 14 dB) in the strong electric field.

Thus, it can be understood that the resistance in the presence of the LPF 14 is more improved by 7 dB to 11 dB than the resistance in the absence of the LPF 14.

As understood from the above description, a high frequency signal received by the antenna 12 ranges from an FM radio broadcast band (76 MHz-90 MHz band: first frequency band) to a television broadcast band (band exceeding 90 MHz: second frequency band) assigned to a frequency higher than the first frequency band. The LPF 14 has an attenuated area corresponding to a television channel of a frequency higher out of the two television channels causing intermodulation interference to an FM radio broadcast band. A part of the frequency component constituting the high frequency signal captured by the antenna 12 is extracted by the LPF 14. The mixer 18 mixes a high frequency signal having the frequency component extracted by the LPF 14 with a local oscillation frequency signal to output an intermediate frequency signal. The demodulator circuit 26 creates an audio signal for FM radio broadcast on the basis of the intermediate frequency signal output from the mixer 18.

Thus, the LPF 14 has an attenuated area corresponding to the television channel causing intermodulation interference, and is provided at the front of the mixer 18. Thus it is possible to prevent intermodulation interference with the FM radio broadcast from occurring. Furthermore, the attenuated area of the LPF 14 corresponds to a television channel of a higher frequency. Thus, it is possible to retain higher receiver sensitivity with respect to the FM radio broadcast band. This makes it possible to comfortably listen to an FM radio broadcast.

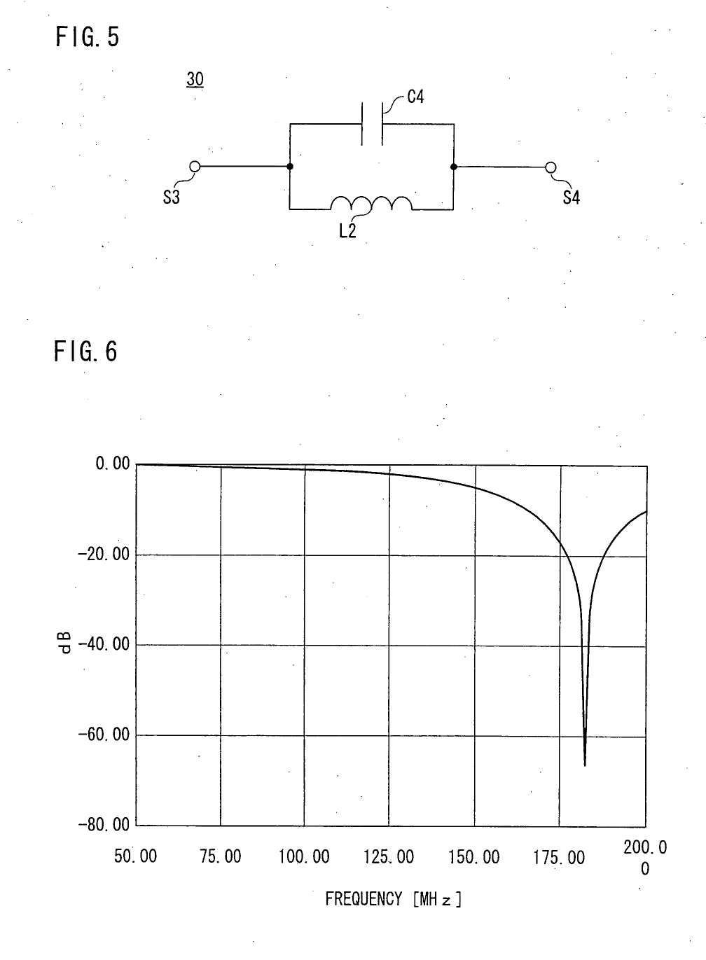

It should be noted that in this embodiment, a description is made by utilizing an LPF, but a trap filter 30 shown in FIG. 5 may be used in place of this. With reference to FIG. 5, the trap filter 30 includes an input terminal S3 and an output terminal S4 respectively connected to the antenna 12 and the RF amplifier circuit 16. One end of a capacitor C4 is connected to the input terminal S3, and the other end of the capacitor C4 is connected to the output terminal S4. An inductor L2 is connected in parallel to the capacitor C4.

The capacitor C4 has a capacity of 15 pF, and the inductor L2 has a coefficient of induction of 51 nH. A frequency response of the trap filter 30 thus constructed is shown in FIG. 6. According to FIG. 6, although it is inferior to the frequency response of the LPF 14, the trap filter 30 also has a frequency response attenuating broadcast audios of channels CH4 and CH6. Thus, it is possible to retain high receiver sensitivity with respect to the FM radio broadcast band while reducing intermodulation interference with the FM radio broadcast, and it becomes possible to comfortably listen to the FM radio broadcast.

Furthermore, in this embodiment, it is assumed that the television broadcast band at a frequency higher than the FM radio broadcast band is provided, but the television broadcast band may be placed at a frequency lower than the FM radio broadcast band. However, in this case, an HPF has to be adopted in place of the LPF 14, which has an attenuated area corresponding to a television channel at a frequency lower out of the two television channels causing intermodulation interference with the FM radio broadcast band.

Additionally, the coefficient of induction of the inductor and a capacitance of the capacitor forming each of the LPF 14 and the trap filter 30 may be modified as necessary depending on the change in environment.

In addition, if there is no need to attach importance to the receiver sensitivity of the FM radio broadcast, the attenuated area of the filter may be brought into correspondence with either of the two television channels causing intermodulation interference, and may be brought into correspondence with both of the two television channels.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An FM radio receiver, comprising:
an antenna receiving a high frequency signal ranging from a first frequency band for FM radio broadcasting to a second frequency band for television broadcasting;
a mixer for mixing the high frequency signal received by said antenna with a local oscillation frequency signal to create an intermediate frequency signal; and
a filter provided between said antenna and said mixer, and having an attenuated area corresponding to at least one television channel out of two television channels causing intermodulation interference with said first frequency band.

2. An FM radio receiver according to claim 1, wherein the attenuated area noted by said filter corresponds to the television channel farther from said first frequency band out of said two television channels.

3. An FM radio receiver according to claim 1, wherein said second frequency band is assigned to a frequency higher than said first frequency band.

4. An FM radio receiver according to claim 1, wherein said filter includes an inductor and a first capacitor connected in parallel with each other for LC resonance.

5. An FM radio receiver according to claim 4, wherein said filter further includes a second capacitor provided between one end of said inductor and a plane of reference potential, and a third capacitor provided between the other end of said inductor and said plane of reference potential.

6. An FM radio receiver according to claim 1, further comprising a first amplifier provided between said filter and said mixer for amplifying an output of said filter.

7. An FM radio receiver according to claim 1, further comprising:
an extractor provided at a back of said mixer for extracting a predetermined frequency component included in said intermediate frequency signal;
a second amplifier for amplifying the predetermined frequency component extracted by said extractor; and
a demodulator for demodulating the predetermined frequency component amplified by said second amplifier.
